(19) United States
(12) Patent Application Publication
(10) Pub. No.: US 2025/0283818 A1
(43) Pub. Date: Sep. 11, 2025

(54) METHOD FOR DETERMINING AT LEAST ONE ANALYTE OF INTEREST

(71) Applicant: Roche Diagnostics Operations, Inc., Indianapolis, IN (US)

(72) Inventors: Frank Bergmann, Iffeldorf (DE); Kay Hagedorn, Penzberg (DE); Dieter Heindl, Muenchen (DE); Martin Rempt, Penzberg (DE)

(21) Appl. No.: 19/217,951

(22) Filed: May 23, 2025

Related U.S. Application Data
(63) Continuation of application No. PCT/EP2023/082470, filed on Nov. 21, 2023.

(30) Foreign Application Priority Data
Nov. 23, 2022 (EP) 22209071.4

(51) Int. Cl. G01N 21/64; G01N 21/65

(52) U.S. Cl. CPC G01N 21/6428; G01N 21/65; G01N 2021/6432; G01N 2021/6439

(57) ABSTRACT

The present invention relates to a method for determining at least one analyte of interest and the uses thereof. The present invention further relates to a diagnostic system, a kit and the use thereof for determining at least one analyte of interest.

### FIELD OF THE INVENTION

The present invention relates to a method for determining at least one analyte of interest and the uses thereof. The present invention further relates to a diagnostic system, a kit and the use thereof for determining at least one analyte of interest.

### BACKGROUND OF THE INVENTION

Raman spectroscopy is a technique specialized in measuring the frequency shift of inelastic scattered light from the sample when the photon from incident light strikes a molecule and produce a scattered photon. RAMAN spectra gives qualitative and quantitative information's of analytes even in a matrix, for example in an organic or inorganic, e.g. aqueous, matrix.

The main problem of (organic) matrices are that the sample and/or the matrix components have a strong fluorescence effect beside the RAMAN effect, wherein the parallel and more sensitive effect of fluorescence limits this process. This causes the problem that the information of analytes from the RAMAN spectra can not be detected quite well.

Therefore, fluorescence quenchers and selective quenching of fluorescence is highly of interest for analytical techniques.

Quenching of fluorescence signal has been tried in the past by reducing the fluorescence lifetime adding KI to the solution. However, a molecular quenching was never performed.

There is thus an urgent need in the art to overcome the above mentioned problems.

It is an object of the present invention to provide a method for determining at least one analyte of interest. Further, it is an object of the present invention to provide a diagnostic system, a kit and the use thereof for determining at least one analyte of interest.

This object is or these objects are solved by the subject matter of the independent claims. Further embodiments are subjected to the dependent claims.

### SUMMARY OF THE INVENTION

In the following, the present invention relates to the following apects:

In a first aspect, the present invention relates to a method for determining at least one analyte of interest comprising the following steps:
a) Providing
the at least one analyte of interest, which is capable of emitting scattered electromagnetic radiation when exciting with monochromatic electromagnetic radiation having a maximum excitation wavelength λₘₐₓ₁, and
a fluorophore, which is capable of emitting fluorescent electromagnetic radiation when exciting with the monochromatic electromagnetic radiation having the maximum excitation wavelength λₘₐₓ₁,
b) Providing a quencher, which is capable of quenching the fluorophore's fluorescent electromagnetic radiation when exciting with the monochromatic electromagnetic radiation having the maximum excitation wavelength λₘₐₓ₁,
c) Mixing the at least one analyte of interest, the fluorophore and the quencher for forming a sample,
d) Performing RAMAN spectroscopy, and
e) Determining the at least one analyte of interest via RAMAN spectroscopy.

In a second aspect, the present invention relates to the use of the method of the first aspect of the present invention for determining the at least one analyte of interest.

In a third aspect, the present invention relates to diagnostic system for determining the at least one analyte of interest in a sample.

In a fourth aspect, the present invention relates to a kit suitable to perform a method of the first aspect of the invention comprising or consisting of
(A) at least one analyte of interest, preferably a deuterated analyte of interest as an internal standard, and
(B) a quencher.

In a fifth aspect, the use of a kit of the fourth aspect of the invention in a method of the first aspect of the invention.

### LIST OF FIGURES

FIG. 1 shows the RAMAN spectra of a acetonitrile as an analyte of interest.

FIG. 2 shows quenchers having an oligonucleotide as a hydrophilic group.

FIGS. 3A to 3C show RAMAN spectra for acetonitrile as an analyte of interest.

FIGS. 4A and 4B show the RAMAN spectra of a acetonitrile as an analyte of interest in different fluorophore dilution.

FIGS. 5 and 6 shows the the signal to noise ratio as a function of the fluorophore concentration at different quencher concentrations (0 mg/l (Blank), 41.7 mg/l, 62.5 mg/l).

FIG. 7 shows the the signal to noise ratio as a function of the fluorophore concentration at different quencher concentrations in a biological matrix environment, such as blood serum (0 mg/l (Blank), 62.5 mg/l).

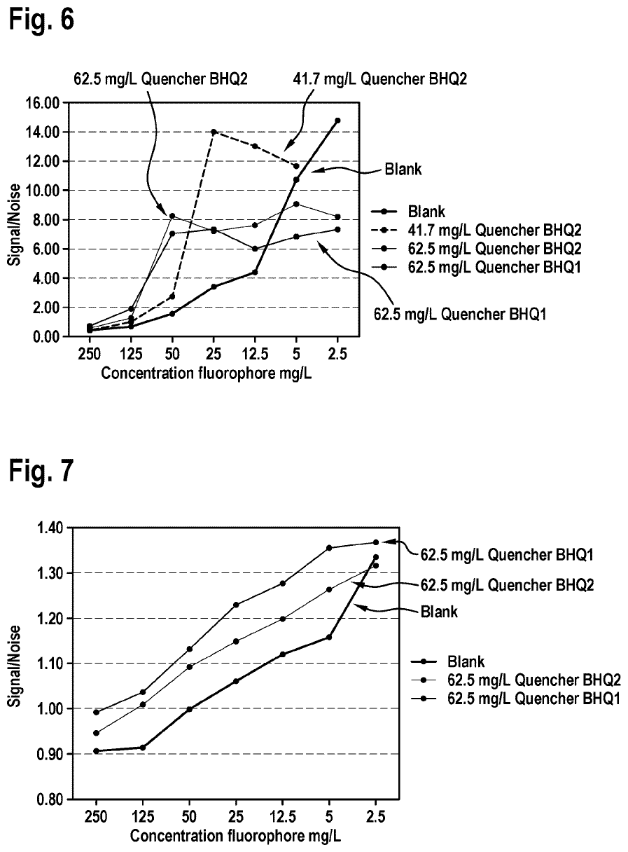

### DETAILED DESCRIPTION OF THE INVENTION

Before the present invention is described in detail below, it is to be understood that this invention is not limited to the particular embodiments and examples described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Several documents are cited throughout the text of this specification. Each of the documents cited herein (including all patents, patent applications, scientific publications, manufacturer's specifications, instructions etc.), whether supra or infra, is hereby incorporated by reference in its entirety. In the event of a conflict between the definitions or teachings of such incorporated references and definitions or teachings recited in the present specification, the text of the present specification takes precedence.

In the following, the elements of the present invention will be described. These elements are listed with specific embodiments, however, it should be understood that they may be combined in any manner and in any number to create additional embodiments. The various described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

### Definitions

The word “comprise”, and variations such as “comprises” and “comprising”, will be understood to imply the inclusion of a stated integer or step or group of integers or steps but not the exclusion of any other integer or step or group of integers or steps.

As used in this specification and the appended claims, the singular forms “a”, “an”, and “the” include plural referents, unless the content clearly dictates otherwise.

Percentages, concentrations, amounts, and other numerical data may be expressed or presented herein in a “range” format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “4% to 20%” should be interpreted to include not only the explicitly recited values of 4% to 20%, but to also include individual values and sub-ranges within the indicated range. Thus, included in this numerical range are individual values such as 4, 5, 6, 7, 8, 9, 10, . . . 18, 19, 20% and sub-ranges such as from 4-10%, 5-15%, 10-20%, etc. This same principle applies to ranges reciting minimal or maximal values. Furthermore, such an interpretation should apply regardless of the breadth of the range or the characteristics being described.

The term “about” when used in connection with a numerical value is meant to encompass numerical values within a range having a lower limit that is 5% smaller than the indicated numerical value and having an upper limit that is 5% larger than the indicated numerical value.

In the context of the present disclosure, the term “analyte”, “analyte molecule”, or “analyte(s) of interest” are used interchangeably referring the chemical specis to be analysed via RAMAN spectrometry. Chemical specis suitable to be analysed via RAMAN spectrometry, i.e. analytes, can be any kind of molecule present in a living organism, include but are not limited to nucleic acid (e.g. DNA, mRNA, miRNA, rRNA etc.), amino acids, peptides, proteins (e.g. cell surface receptor, cytosolic protein etc.), metabolite or hormones (e.g. testosterone, estrogen, estradiol, etc.), fatty acids, lipids, carbohydrates, steroids, ketosteroids, secosteroids (e.g. Vitamin D), molecules characteristic of a certain modification of another molecule (e.g. sugar moieties or phosphoryl residues on proteins, methyl-residues on genomic DNA) or a substance that has been internalized by the organism (e.g. therapeutic drugs, drugs of abuse, toxin, etc.) or a metabolite of such a substance. Such analyte may serve as a biomarker. In the context of present invention, the term “biomarker” refers to a substance within a biological system that is used as an indicator of a biological state of said system.

Analytes or an analyte of interest may be present in a sample, in particular a biological or clinical sample. The term “biological or clinical sample” are used interchangeably herein, referring to a part or piece of a tissue, organ or individual, typically being smaller than such tissue, organ or individual, intended to represent the whole of the tissue, organ or individual. Upon analysis a biological or clinical sample provides information about the tissue status or the health or diseased status of an organ or individual. Examples of biological or clinical samples include but are not limited to fluid samples such as blood, serum, plasma, synovial fluid, spinal fluid, urine, saliva, and lymphatic fluid, or solid biological or clinical samples such as dried blood spots and tissue extracts. Further examples of biological or clinical samples are cell cultures or tissue cultures.

The term “chromatography” refers to a process in which a chemical mixture carried by a liquid or gas is separated into components as a result of differential distribution of the chemical entities as they flow around or over a stationary liquid or solid phase. In embodiments of the present invention, the method or sample element or device or kit are free of a chromatography step and chromatography unit, respectively.

The term “liquid chromatography” or “LC” refers to a process of selective retardation of one or more components of a fluid solution as the fluid uniformly percolates through a column of a finely divided substance, or through capillary passageways. The retardation results from the distribution of the components of the mixture between one or more stationary phases and the bulk fluid, (i.e., mobile phase), as this fluid moves relative to the stationary phase(s). Methods in which the stationary phase is more polar than the mobile phase (e.g., toluene as the mobile phase, silica as the stationary phase) are termed normal phase liquid chromatography (NPLC) and methods in which the stationary phase is less polar than the mobile phase (e.g., water-methanol mixture as the mobile phase and C18 (octadecylsilyl) as the stationary phase) is termed reversed phase liquid chromatography (RPLC).

“High performance liquid chromatography” or “HPLC” refers to a method of liquid chromatography in which the degree of separation is increased by forcing the mobile phase under pressure through a stationary phase, typically a densely packed column. Typically, the column is packed with a stationary phase composed of irregularly or spherically shaped particles, a porous monolithic layer, or a porous membrane. HPLC is historically divided into two different sub-classes based on the polarity of the mobile and stationary phases. Methods in which the stationary phase is more polar than the mobile phase (e.g., toluene as the mobile phase, silica as the stationary phase) are termed normal phase liquid chromatography (NPLC) and the opposite (e.g., water-methanol mixture as the mobile phase and C18 (octadecylsilyl) as the stationary phase) is termed reversed phase liquid chromatography (RPLC). Micro LC refers to a HPLC method using a column having a norrow inner column diameter, typically below 1 mm, e.g. about 0.5 mm. “Ultra high performance liquid chromatography” or “UHPLC” refers to a HPLC method using a pressure of 120 MPa (17,405 lbf/in2), or about 1200 atmospheres. Rapid LC refers to an LC method using a column having an inner diameter as mentioned above, with a short length <2 cm, e.g. 1 cm, applying a flow rate as mentioned above and with a pressure as mentioned above (Micro LC, UHPLC). The short Rapid LC protocol includes a trapping/wash/elution step using a single analytical column and realizes LC in a very short time <1 min.

Further well-known LC modi include hydrophilic interaction chromatography (HILIC), size-exclusion LC, ion exchange LC, and affinity LC.

LC separation may be single-channel LC or multi-channel LC comprising a plurality of LC channels arranged in parallel. In LC analytes may be separated according to their polarity or log P value, size or affinity, as generally known to the skilled person.

The term “electromagnetic radiation” is a broad term and is to be given its ordinary and customary meaning to a person of ordinary skill in the art and is not to be limited to a special or customized meaning. The term specifically may refer, without limitation, to a form of energy waves as it travels through space (vacuum or matter). It can consist of both electric and magnetic field components. The energy waves oscillate in phase perpendicular to each other and perpendicular to the direction of energy propagation. Electromagnetic radiation is classified into several types according to the frequency of its wave. These types include (in order of decreasing frequency and increasing wavelength) cosmic radiation, gamma radiation, X-ray radiation, ultraviolet radiation, visible radiation, IR radiation, terahertz radiation, microwave radiation, and radio waves. A small and variable window of frequencies is sensed by the eyes of various organisms, which is known as the visible spectrum (λ0.4-0.7 μm) or light.

The term “monochromatic electromagnetic radiation” is a broad term and is to be given its ordinary and customary meaning to a person of ordinary skill in the art and is not to be limited to a special or customized meaning. The term specifically may refer, without limitation, to electromagnetic radiation, especially visible radiation, of only one frequency or wavelength. Completely monochromatic radiation cannot be produced, but lasers produce radiation within a very narrow frequency band.

The term “scattered electromagnetic radiation” refers to electromagnetic radiation, which is scattered.

The term “patient sample” as used herein refers to a biological sample obtained for the purpose of evaluation in vitro. In the methods of the present invention, the sample or patient sample preferably may comprise any body fluid. Preferred samples are whole blood, serum or plasma. As the skilled artisan will appreciate, any such assessment is made in vitro. The patient sample is discarded afterwards. The patient sample is solely used for the in vitro method of the invention and the material of the patient sample is not transferred back into the patient's body.

In the context of the present disclosure, the sample may be derived from an “individual” or “subject”. Typically, the subject is a mammal. Mammals include, but are not limited to, domesticated animals (e.g., cows, sheep, cats, dogs, and horses), primates (e.g., humans and non-human primates such as monkeys), rabbits, and rodents (e.g., mice and rats).

The term “hemolysis reagent” (HR) refers to reagents which lyse cells present in a sample, in the context of this invention hemolysis reagents in particular refer to reagents which lyse the cell present in a blood sample including but not limited to the erythrocytes present in whole blood samples. A well known hemolysis reagent is water (H₂O). Further examples of hemolysis reagents include but are not limited to deionized water, liquids with high osmolarity (e.g. 8M urea), ionic liquids, and different detergents.

The term “fluorescent electromagnetic radiation” is a broad term and is to be given its ordinary and customary meaning to a person of ordinary skill in the art and is not to be limited to a special or customized meaning. Therefore, it is not explained here in detail.

The term “quenching” is a broad term and is to be given its ordinary and customary meaning to a person of ordinary skill in the art and is not to be limited to a special or customized meaning. Therefore, it is not explained here in detail.

The term “Förster resonance energy transfer” is a broad term and is to be given its ordinary and customary meaning to a person of ordinary skill in the art and is not to be limited to a special or customized meaning. Therefore, it is not explained here in detail.

The term “water based sample” can mean that the quencher was modified to be water soluble up to a water content of 100%.

The term “hydrophobic” can mean that compounds are only minimal or not soluble in polar solvents such as ethanol, methanol or water.

A “clinical diagnostics system” is a laboratory automated apparatus dedicated to the analysis of samples for in vitro diagnostics. The clinical diagnostics system may have different configurations according to the need and/or according to the desired laboratory workflow. Additional configurations may be obtained by coupling a plurality of apparatuses and/or modules together. A “module” is a work cell, typically smaller in size than the entire clinical diagnostics system, which has a dedicated function. This function can be analytical but can be also pre-analytical or post analytical or it can be an auxiliary function to any of the pre-analytical function, analytical function or post-analytical function. In particular, a module can be configured to cooperate with one or more other modules for carrying out dedicated tasks of a sample processing workflow, e.g. by performing one or more pre-analytical and/or analytical and/or post-analytical steps. In particular, the clinical diagnostics system can comprise one or more analytical apparatuses, designed to execute respective workflows that are optimized for certain types of analysis, e.g. clinical chemistry, immunochemistry, coagulation, hematology, liquid chromatography separation, mass spectrometry, RAMAN spectrometry etc. Thus the clinical diagnostic system may comprise one analytical apparatus or a combination of any of such analytical apparatuses with respective workflows, where pre-analytical and/or post analytical modules may be coupled to individual analytical apparatuses or be shared by a plurality of analytical apparatuses. In alternative pre-analytical and/or post-analytical functions may be performed by units integrated in an analytical apparatus. The clinical diagnostics system can comprise functional units such as liquid handling units for pipetting and/or pumping and/or mixing of samples and/or reagents and/or system fluids, and also functional units for sorting, storing, transporting, identifying, separating, detecting. The clinical diagnostic system can comprise a sample preparation station for the automated preparation of samples comprising analytes of interest, optionally a liquid chromatography (LC) separation station comprising a plurality of LC channels and/or optionally a sample preparation/LC interface for inputting prepared samples into any one of the LC channels. The clinical diagnostic system can further comprise a controller programmed to assign samples to pre-defined sample preparation workflows each comprising a pre-defined sequence of sample preparation steps and requiring a pre-defined time for completion depending on the analytes of interest. The clinical diagnostic system can further comprise a RAMAN spectrometer and an LC/RAMAN interface for connecting the LC separation station to the RAMAN spectrometer. The term “automatically” or “automated” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user.

A “sample preparation station” can be a pre-analytical module coupled to one or more analytical apparatuses or a unit in an analytical apparatus designed to execute a series of sample processing steps aimed at removing or at least reducing interfering matrix components in a sample and/or enriching analytes of interest in a sample. Such processing steps may include any one or more of the following processing operations carried out on a sample or a plurality of samples, sequentially, in parallel or in a staggered manner: pipetting (aspirating and/or dispensing) fluids, pumping fluids, mixing with reagents, incubating at a certain temperature, heating or cooling, centrifuging, separating, filtering, sieving, drying, washing, resuspending, aliquoting, transferring, storing, etc.).

Typically, an “internal standard” (ISTD) is a known amount of a substance which exhibits similar properties as the analyte of interest when subjected to the RAMAN spectrometric detection workflow (i.e. including any pre-treatment, enrichment and actual detection step). Although the ISTD exhibits similar properties as the analyte of interest, it is still clearly distinguishable from the analyte of interest. Exemplified, during chromatographic separation, such as gas or liquid chromatography, the ISTD has about the same retention time as the analyte of interest from the sample. Thus, both the analyte and the ISTD enter the RAMAN spectrometer at the same time. The ISTD however, exhibits a different molecular mass than the analyte of interest from the sample. This allows a RAMAN spectrometric distinction between ions from the ISTD and ions from the analyte by means of their different mass/charge (m/z) ratios. Both are subject to fragmentation and provide daughter ions. These daughter ions can be distinguished by means of their m/z ratios from each other and from the respective parent ions. Consequently, a separate determination and quantification of the signals from the ISTD and the analyte can be performed. Since the ISTD has been added in known amounts, the signal intensity of the analyte from the sample can be attributed to a specific quantitative amount of the analyte. Thus, the addition of an ISTD allows for a relative comparison of the amount of analyte detected, and enables unambiguous identification and quantification of the analyte(s) of interest present in the sample when the analyte(s) reach the RAMAN spectrometer. Typically, but not necessarily, the ISTD is an isotopically labeled variant (comprising e.g. ²H, ¹³C, or ¹⁵N etc. label) of the analyte of interest.

A “kit” is any manufacture (e.g., a package or container) comprising at least one reagent, e.g., a medicament for treatment of a disorder, or a probe for specifically detecting a biomarker gene or protein of the invention. The kit is preferably promoted, distributed, or sold as a unit for performing the method of the present invention. Typically, a kit may further comprise carrier means being compartmentalized to receive in close confinement one or more container means such as vials, tubes, and the like. In particular, each of the container means comprises one of the separate elements to be used in the method of the first aspect. Kits may further comprise one or more other reagents including but not limited to reaction catalyst. Kits may further comprise one or more other containers comprising further materials including but not limited to buffers, internal standard, diluents, filters, needles, syringes, and package inserts with instructions for use. A label may be present on the container to indicate that the composition is used for a specific application, and may also indicate directions for either in vivo or in vitro use. The computer program code may be provided on a data storage medium or device such as a optical storage medium (e.g., a Compact Disc) or directly on a computer or data processing device. Moreover, the kit may, comprise standard amounts for the biomarkers as described elsewhere herein for calibration purposes.

### Embodiments

In a first aspect, the present invention relates to a method for determining at least one analyte of interest comprising the following steps:
a) [symbol]
Providing the at least one analyte of interest, which is capable of emitting scattered electromagnetic radiation when exciting with monochromatic electromagnetic radiation having a maximum excitation wavelength λₘₐₓ₁, and
Providing a fluorophore, which is capable of emitting fluorescent electromagnetic radiation when exciting with the monochromatic electromagnetic radiation having the maximum excitation wavelength λₘₐₓ₁,
b) Providing a quencher, which is capable of quenching the fluorophore's fluorescent electromagnetic radiation when exciting with the monochromatic electromagnetic radiation having the maximum excitation wavelength λₘₐₓ₁,
c) Mixing the at least one analyte of interest, the fluorophore and the quencher for forming a sample,
d) Performing RAMAN spectroscopy, and
e) Determining the at least one analyte of interest via RAMAN spectroscopy.

The inventors surprisingly found that subject matters of the present invention, in particular the method according to the first aspect of the invention, show a simple and robust way to overcome the above-mentioned disadvantages. Fluorescence as major problem of RAMAN spectroscopy is overcome by the described simple solution to measure fast and reliable RAMAN Spectra even in systems where the fluorescence cannot be avoided or being removed.

In particular, the method is performed with fluorescence quenchers with a hydrophilic group, e.g. oligonucleotide to enhance their solubility in water in order to reduce the fluorescence by mixing the analyte sample with the quencher.

According to step a) at least one analyte of interest is provided. The at least one analyte is capable of emitting scattered electromagnetic radiation when exciting with monochromatic electromagnetic radiation having a maximum excitation wavelength λₘₐₓ₁.

In embodiments of the first aspect of the invention, the scattered electromagnetic radiation is an inelastic scattered electromagnetic radiation.

In embodiments of the first aspect of the invention, the scattered electromagnetic radiation is a Stokes scattering and/or an Anti-Stokes scattering. The scateres electromagnetic readiation can be measured by RAMAN spectroscopy. RAMAN spectroscopy is a technique specialized in measuring the frequency shift of inelastic scattered light from the sample when the photon from incident light or electromagnetic radiation strikes a molecule and produce a scattered photon. The out coming scattered light or electromagnetic radiation can be a photon with a lower frequency than the original photon and in that case, it is known as Stokes RAMAN scattering or with higher frequency and known as Anti-Stokes RAMAN scattering.

In embodiments of the first aspect of the invention, the maximum excitation wavelength λₘₐₓ₁ of the monochromatic electromagnetic radiation is smaller than 1064 nm, e.g. 532 nm, 633 nm.

In embodiments of the first aspect of the invention, the monochromatic electromagnetic radiation is generated by a krypton ion laser (530.9 and 647.1 nm), He:Ne laser (632.8 nm), Nd:YAG laser (1064 nm and 532 nm), argon ion laser (488.0 and 514.5 nm), or diode laser (630 and 780 nm).

In embodiments of the first aspect of the invention, the analyte of interest is selected from is selected from the group consisting of nucleic acid, amino acid, peptide, protein, metabolite, hormones, fatty acid, lipid, carbohydrate, steroid, ketosteroid, secosteroid, a molecule characteristic of a certain modification of another molecule, a substance that has been internalized by the organism, a metabolite of such a substance and combination thereof.

In embodiments of the first aspect of the invention, the analyte of interest is selected from the group consisiting of testosterone, epitestosterone, dihydrotestosterone (DHT), desoxymethyltestosterone (DMT), tetrahydrogestrinone (THG), aldosterone, estrone, 4-hydroxyestrone, 2-methoxyestrone, 2-hydroxyestrone, 16-ketoestradiol, 16-alpha-hydroxyestrone, 2-hydroxyestrone-3-methylether, prednisone, prednisolone, pregnenolone, progesterone, dehydroepiandrosterone (DHEA), 17-hydroxypregnenolone, 17-hydroxyprogesterone, androsterone, epiandrosterone, 44-androstenedione, 11-deoxycortisol, corticosterone, 21-deoxycortisol, 11-deoxycorticosterone, allopregnanolone and aldosterone, Δ8-tetrahydrocannabinolic acid, benzoylecgonin, salicylic acid, 2-hydroxybenzoic acid, gabapentin, pregabalin, valproic acid, vancomycin, methotrexate, mycophenolic acid, montelukast, repaglinide, furosemide, telmisartan, gemfibrozil, diclofenac, ibuprofen, indomethacin, zomepirac, isoxepac and penicillin. In embodiments of the first aspect of the present invention, the analyte molecule comprising one or more carboxyl groups is an amino acid selected from the group consisting of arginine, lysine, aspartic acid, glutamic acid, glutamine, asparagine, histidine, serine, threonine, tyrosine, cysteine, tryptophan, alanine, isoleucine, leucine, methionine, phenyalanine, valine, proline and glycine, pyridoxal, N-acetyl-D-glucosamine, alcaftadine, streptomycin and josamycin, cocaine, heroin, Ritalin, aceclofenac, acetylcholine, amcinonide, amiloxate, amylocaine, anileridine, aranidipine artesunate and pethidine, cantharidin, succinic anhydride, trimellitic anhydride and maleic anhydride, cholecalciferol (vitamin D3), ergocalciferol (vitamin D2), calcifediol, calcitriol, tachysterol, lumisterol and tacalcitol, 25-hydroxyvitamin D2, 25-hydroxyvitamin D3 (calcifediol), 3-epi-25-hydroxyvitamin D2, 3-epi-25-hydroxyvitamin D3, 1,25-dihydroxyvitamin D2, 1,25-dihydroxyvitamin D3 (calcitriol), 24,25-dihydroxyvitamin D2, 24,25-dihydroxyvitamin D3, vitamin A, tretinoin, isotretinoin, alitretinoin, natamycin, sirolimus, amphotericin B, nystatin, everolimus, temsirolimus and fidaxomicin, benzyl alcohol, menthol, L-carnitine, pyridoxine, metronidazole, isosorbide mononitrate, guaifenesin, clavulanic acid, Miglitol, zalcitabine, isoprenaline, aciclovir, methocarbamol, tramadol, venlafaxine, atropine, clofedanol, alpha-hydroxyalprazolam, alpha-Hydroxytriazolam, lorazepam, oxazepam, Temazepam, ethyl glucuronide, ethylmorphine, morphine, morphine-3-glucuronide, buprenorphine, codeine, dihydrocodeine, p-hydroxypropoxyphene, O-desmethyltramadol, Desmetramadol, dihydroquinidine and quinidine. In embodiments of the first aspect of the present invention, wherein the analyte molecule comprises more than one hydroxyl groups, the analyte is selected from the group consisting of vitamin C, glucosamine, mannitol, tetrahydrobiopterin, cytarabine, azacitidine, ribavirin, floxuridine, Gemcitabine, Streptozotocin, adenosine, Vidarabine, cladribine, estriol, trifluridine, clofarabine, nadolol, zanamivir, lactulose, adenosine monophosphate, idoxuridine, regadenoson, lincomycin, clindamycin, Canagliflozin, tobramycin, netilmicin, kanamycin, ticagrelor, epirubicin, doxorubicin, arbekacin, streptomycin, ouabain, amikacin, neomycin, framycetin, paromomycin, erythromycin, clarithromycin, azithromycin, vindesine, digitoxin, digoxin, metrizamide, acetyldigitoxin, deslanoside, Fludarabine, clofarabine, gemcitabine, cytarabine, capecitabine, vidarabine, plicamycin, thiomandelic acid, DL-captopril, DL-thiorphan, N-acetylcysteine, D-penicillamine, glutathione, L-cysteine, zofenoprilat, tiopronin, dimercaprol, succimer, glutathione disulfide, dipyrithione, selenium sulfide, disulfiram, lipoic acid, L-cystine, fursultiamine, octreotide, desmopressin, vapreotide, terlipressin, linaclotide and peginesatide. Selenium sulfide can be selenium disulfide, SeS₂, or selenium hexasulfide, Se₂S₆, Carbamazepine-10,11-epoxide, carfilzomib, furosemide epoxide, fosfomycin, sevelamer hydrochloride, cerulenin, scopolamine, tiotropium, tiotropium bromide, methylscopolamine bromide, eplerenone, mupirocin, natamycin, and troleandomycin, estrogen, estrogen-like compounds, estrone (E1), estradiol (E2), 17a-estradiol, 17b-estradiol, estriol (E3), 16-epiestriol, 17-epiestriol, and 16, 17-epiestriol and/or metabolites thereof. In embodiments, the metabolites are selected from the group consisiting of estriol, 16-epiestriol (16-epiE3), 17-epiestriol (17-epiE3), 16,17-epiestriol (16,17-epiE3), 16-ketoestradiol (16-ketoE2), 16a-hydroxyestrone (16a-OHE1), 2-methoxyestrone (2-MeOE1), 4-methoxyestrone (4-MeOE1), 2-hydroxyestrone-3-methyl ether (3-MeOE1), 2-methoxyestradiol (2-MeOE2), 4-methoxyestradiol (4-MeOE2), 2-hydroxyestrone (2-OHE1), 4-hydroxyestrone (4-OHE1), 2-hydroxyestradiol (2-OHE2), estrone (E1), estrone sulfate (E1s), 17a-estradiol (E2a), 17b-estradiol (E2B), estradiol sulfate (E2S), equilin (EQ), 17a-dihydroequilin (EQa), 17b-dihydroequilin (EQb), Equilenin (EN), 17-dihydroequilenin (ENa), 17α-dihydroequilenin, 17β-dihydroequilenin (ENb), Δ8,9-dehydroestrone (dE1), Δ8,9-dehydroestrone sulfate (dE1s), Δ9-tetrahydrocannabinol, mycophenolic acid. β or b can be used interchangeable. α and a can be used interchangeable, 3,4-methylenedioxyamphetamine, 3,4-methylenedioxy-N-ethylamphetamine, 3,4-methylenedioxymethamphetamine, Amphetamine, Methamphetamine, N-methyl-1,3-benzodioxolylbutanamine, 7-aminoclonazepam, 7-aminoflunitrazepam, 3,4-dimethylmethcathinone, 3-fluoromethcathinone, 4-methoxymethcathinone, 4-methylethcathinone, 4-methylmethcathinone, amfepramone, butylone, ethcathinone, elephedrone, methcathinone, methylone, methylenedioxypyrovalerone, benzoylecgonine, dehydronorketamine, ketamine, norketamine, methadone, normethadone, 6-acetylmorphine, diacetylmorphine, morphine, norhydrocodone, oxycodone, oxymorphone, phencyclidine, norpropoxyphene, amitriptyline, clomipramine, dothiepin, doxepin, imipramine, nortriptyline, trimipramine, fentanyl, glycylxylidide, lidocaine, monoethylglycylxylidide, N-acetylprocainamide, procainamide, pregabalin, 2-Methylamino-1-(3,4-methylendioxyphenyl) butan, N-methyl-1,3-benzodioxolylbutanamine, 2-Amino-1-(3,4-methylendioxyphenyl) butan, 1,3-benzodioxolylbutanamine, normeperidine, O-Destramadol, desmetramadol, tramadol, lamotrigine, Theophylline, amikacin, gentamicin, tobramycin, vancomycin, Methotrexate, Gabapentin sisomicin and 5-methylcytosine, ribose, desoxyribose, arabinose, ribulose, glucose, mannose, galactose, fucose, fructose, N-acetylglucosamine, N-acetylgalactosamine, neuraminic acid, N-acetylneurominic acid, etc.. In embodiments, the analyte molecule is an oligosaccharide, in particular selected from the group consisting of a disaccharide, trisaccharid, tetrasaccharide, polysaccharide. In embodiments of the first aspect of the present invention, the disaccharide is selected from the group consisting of sucrose, maltose and lactose. In embodiments of the first aspect of the present invention, the analyte molecule is a substance comprising above described mono-, di-, tri-, tetra-, oligo- or polysaccharide moiety, zidovudine and azidocillin.

Such analyte molecules may be present in a sample, e.g. a biological or clinical samples such as body liquids, e.g. blood, serum, plasma, urine, saliva, spinal fluid, etc., tissue or cell extracts, etc.

In embodiments of the first aspect of the present invention, the sample is selected from the group consisting of blood, serum, plasma, synovial fluid, spinal fluid, urine, saliva, and lymphatic fluid, cell cultures, tissue cultures and solid samples such as dried blood spots or tissue extracts. In some embodiments of the first aspect of the present invention, the analyte molecules may be present in a sample which is a purified or partially purified sample, e.g. a purified or partially purified protein mixture or extract.

In embodiments of the first aspect of the present invention, the sample is obtained from a patient sample, which is selected from a group consisting of serum, plasma and whole blood sample from an individual.

In embodiments of the first aspect of the present invention, the sample is a human sample, preferably a hemolysed whole-blood sample, particularly a hemolysed human whole-blood sample. The hemolysed whole-blood sample can be hemolysed with a hemolysis reagent.

According to step a), the fluorophore is provided. The fluorophore is capable of emitting fluorescent electromagnetic radiation when exciting with the monochromatic electromagnetic radiation having the maximum excitation wavelength λₘₐₓ₁.

In embodiments of the first aspect of the present invention, the fluorophore is selected from the group consisting of chemicals comprising several combined aromatic groups, or planar molecules or cyclic molecules with several π bonds. As examples the followings can be listed

Xanthene derivatives: fluorescein, rhodamine, Oregon green, eosin, and Texas red

Cyanine derivatives: cyanine, indocarbocyanine, oxacarbocyanine, thiacarbocyanine, and merocyanine

Squaraine derivatives and ring-substituted squaraines, including Seta and Square dyes

Squaraine rotaxane derivatives: See Tau dyes

Naphthalene derivatives (dansyl and prodan derivatives)

Coumarin derivatives

Oxadiazole derivatives: pyridyloxazole, nitrobenzoxadiazole and benzoxadiazole

Anthracene derivatives: anthraquinones, including DRAQ5, DRAQ7 and CyTRAK Orange

Pyrene derivatives: cascade blue, etc.

Oxazine derivatives: Nile red, Nile blue, cresyl violet, oxazine 170, etc.

Acridine derivatives: proflavin, acridine orange, acridine yellow, etc.

Arylmethine derivatives: auramine, crystal violet, malachite green

Tetrapyrrole derivatives: porphin, phthalocyanine, bilirubin

Dipyrromethene derivatives: BODIPY, aza-BODIPY

According to method step b) a quencher is provided. The quencher is capable of quenching the fluorophore's fluorescent electromagnetic radiation when exciting with the monochromatic electromagnetic radiation having the maximum excitation wavelength λₘₐₓ₁.

In embodiments of the first aspect of the present invention, the quencher comprises a hydrophilic group, which is selected from the following: SO₄²⁻; PO₄³⁻, oligonucleotide, quaternary amine, PEG-group, alcohol, COOH.

In embodiments of the first aspect of the present invention, oligonucleotide is an oligomer with variant number of nucleotides with adenine, cytosine, guanine and/or thymine attached.

In embodiments of the first aspect of the present invention, quaternary amine is (CH₃)₄NCl or (CH₃CH₂)₄NCl.

In embodiments of the first aspect of the present invention, PEG-group is polyethylenglycole with variant numbers of ethylenglycol units, e.g. PEG units between 1 to 100, e.g. 25 or 50.

In embodiments of the first aspect of the present invention, alcohol is OH, CH₃OH, C₂H₅OH, C₃H₇OH, C₄H₉OH.

In embodiments of the first aspect of the present invention, hydrophilic group is an oligonucleotide.

In embodiments of the first aspect of the present invention, the quencher comprises a polyaromatic-azo backbone.

In embodiments of the first aspect of the present invention, the molecules of the quencher and the molecules of the fluorophore have a distance of smaller than 6 nm or 5 nm or 3 nm. Therefore, the quenching process can be take place easily.

In embodiments of the first aspect of the present invention, the excitation wavelength of the quencher is in the range of 530 nm to 540 nm or 570 nm to 590 nm.

In embodiments of the first aspect of the present invention, the excitation wavelength of the quencher is in the range of λₘₐₓ₁ with a tolerance of +/−20 nm, preferably +/−15 nm, +/−10 nm or +/−5 nm.

In embodiments of the first aspect of the present invention, the quenching range (absorption range) of the quencher is in the range of 470 nm to 660 nm, preferably 480 nm to 580 nm (borders included) or 550 nm to 650 nm (borders included).

In embodiments of the first aspect of the present invention, the quenching is a Förster resonance energy transfer.

In embodiments of the first aspect of the present invention, the quencher is a BHQ1 Quencher or a BHQ2 Quencher.

In embodiments of the first aspect of the present invention, the quencher is a BHQ1 Quencher or a BHQ2 Quencher, whererin the BHQ1 Quencher is modified with a oligonucleotide or wherein the BHQ2 Quencher is modified with a oligonucleotide.

In embodiments of the first aspect of the present invention, the quencher comprises the following formula:

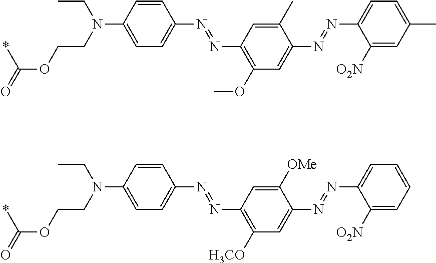 [SMILES: *C(=O)OCCN(CC)c1ccc(/N=N/c2cc(C)c(/N=N/c3ccc(C)cc3[N+](=O)[O-])cc2OC)cc1 ; *C(=O)OCCN(CC)c1ccc(/N=N/c2cc(OC)c(/N=N/c3ccccc3[N+](=O)[O-])cc2OC)cc1]

Structure of BHQ1 and BHQ2 is modified with Oligonucleotide (*=5′−TTx−3′, X=BHQ1 or BHQ2).

According to method step c) the at least one analyte of interest, the fluorophore and the quencher are mixed for forming a sample.

In embodiments of the first aspect of the present invention, the mixing can be performed by combining all components, fluorophore, quencher, analyte and solvent by shaking or stirring in a container of choice.

In embodiments of the first aspect of the present invention, the sample is a water based sample.

In embodiments of the first aspect of the present invention, the ratio fluorophore to quencher is in the range of 4/1 to 1/25.

In embodiments of the first aspect of the present invention, the sample is a solvent based sample and the quencher is hydrophobic.

According to method step d) RAMAN spectroscopy is performed, in particular the sample is measured by RAMAN spectroscopy. In particular, the frequency shift of inelastic scattered electromagnetic radiation from the sample is measured when the photon from incident electromagnetic radiation strikes a molecule and produce a scattered photon.

In embodiments of the first aspect of the present invention, RAMAN spectroscopy can be performed by a RAMAN spectrometer.

In embodiments of the first aspect of the present invention, a Raman spectrometer comprises a radiation source, monochromator, sample holder and detector. Dispersive Raman spectroscopy and Fourier transform Raman spectroscopy can be performed, which are different in their laser sources and by the method of detection for Raman scattering.

In embodiments of the first aspect of the present invention, step (d) is performed in a liquid phase.

According to method step e) the at least one analyte of interest is determined via RAMAN spectroscopy. In order to get the signal to noise ratio from the spectra, the the maximum intensitiy of the fluorescence signal of the fluorophore and the maximum intensity of a strong signal of the analyte can be used.

In a second aspect, the present invention relates to the use of the method of the first aspect of the present invention for determining the at least one analyte of interest. All embodiments mentioned for the first aspect of the invention apply for the second aspect of the invention and vice versa.

In embodiments of the second aspect of the present invention, the presence or the level of the at least one analyte of interest in a sample is determined.

In a third aspect, the present invention relates to a diagnostic system for determining the at least one analyte of interest in a sample, comprising a spectrometer having
a radiation source,
a sample holder,
a wavelength selector and
a detector, to carry out the method according to first aspect of the present invention. All embodiments mentioned for the first aspect of the invention and/or second aspect of the invention apply for the third aspect of the invention and vice versa.

In embodiments of the third aspect of the present invention, the radiation source is capable of emitting monochromatic electromagnetic radiation. In particular, the radiation source is a laser. Several types of lasers can be used as the radiation source or excitation source.

In embodiments of the third aspect of the present invention, the radiation source can be selected from the group consisting of krypton ion (530.9 and 647.1 nm), He:Ne (632.8 nm), Nd:YAG (1064 nm and 532 nm) argon ion (488.0 and 514.5 nm), and diode laser (630 and 780 nm). Use of 1064 nm near-IR (NIR) excitation laser can cause a lower fluorescent effect than visible wavelength lasers.

In embodiments of the third aspect of the present invention, RAMAN spectroscopy has the great advantage of remote sensing when it is associated with optical fibers. The optical fibers are responsible to transport Raman signals by collecting the scattered photons. The fiber optic system includes fibers in which the laser excitation can be transmitted along one fiber and the scattered radiations can be transmitted to the detector along different fibers.

In embodiments of the third aspect of the present invention, the RAMAN spectroscopy can be performed by a RAMAN spectrometer. There is several commercially available hand held Raman spectrometers known, which can be used, e.g. the SciAps ReporteRt (formerly DeltaNu, Inc.), the Snowy Range Instrument CBEXt, the Thermo Scientific FirstDefendert (formerly Ahura, Inc.) and the B&W TEK NanoRamt, see e.g. Driscoll, A. J., Harpster, M. H., Johnson, P. A. (2013). The development of surface-enhanced Raman scattering as a detection modality for portable in vitro diagnostics: progress and challenges. Physical Chemistry Chemical Physics, 15(47), 20415-20433.

In embodiments of the third aspect of the present invention, the RAMAN spectroscopy is surface enhanced Raman scattering (SRS), Coherent anti-stoke Raman scattering (CARS), Tip enhanced Raman scattering (TERS) and/or stimulated and resonance Raman spectroscopy.

In embodiments of the third aspect of the present invention, the sample holder can be a cuvette or a well plate that can hold the liquid sample.

In embodiments of the third aspect of the present invention, the wavelength selector comprises a software realated selection of the wave length and an automated switching of mirrors towards the desired radiation source.

In embodiments of the third aspect of the present invention, the detector comprises a CCD camera detector which translates incident photons e.g. Raman signals into electrical signals which gives a wavelength dependent intensity function.

In embodiments of the third aspect of the present invention, the diagnostic system is a clinical diagnostics system.

In embodiments of the fifth aspect of the present invention, the the clinical diagnostic system comprises a sample preparation station.

In embodiments of the fifth aspect of the present invention, the clinical diagnostic system, e.g. the sample preparation station, comprises a buffer unit for receiving a plurality of samples before a new sample preparation start sequence is initiated, where the samples may be individually randomly accessible and the individual preparation of which may be initiated according to the sample preparation start sequence.

The clinical diagnostic system makes use of RAMAN spectrometry more convenient and more reliable and therefore suitable for clinical diagnostics. In particular, high-throughput or more with random access sample preparation and LC separation can be obtained while enabling online coupling to RAMAN spectrometry. Moreover the process can be fully automated increasing the walk-away time and decreasing the level of skills required.

In a fourth aspect, the present invention relates to a kit suitable to perform a method according to the first aspect of the present invention comprising or consisting of
(A) at least one analyte of interest, preferably a deuterated analyte of interest as an internal standard, and
(B) a quencher.

All embodiments mentioned for the first aspect of the invention and/or second aspect of the invention and/or third aspect of the invention apply for the fourth aspect of the invention and vice versa.

In a fifth aspect, the present invention relates to the use of a kit of the fourth aspect of the present invention in a method according to the first aspect of the present invention.

All embodiments mentioned for the first aspect of the invention and/or second aspect of the invention and/or third aspect of the invention and/or fourth aspect of the invention apply for the fifth aspect of the invention and vice versa.

In further embodiments, the present invention relates to the following aspects:

1. A method for determining at least one analyte of interest comprising the following steps:
a) Providing
the at least one analyte of interest, which is capable of emitting scattered electromagnetic radiation when exciting with monochromatic electromagnetic radiation having a maximum excitation wavelength λₘₐₓ₁, and
a fluorophore, which is capable of emitting fluorescent electromagnetic radiation when exciting with the monochromatic electromagnetic radiation having the maximum excitation wavelength λₘₐₓ₁,
b) Providing a quencher, which is capable of quenching the fluorophore's fluorescent electromagnetic radiation when exciting with the monochromatic electromagnetic radiation having the maximum excitation wavelength λₘₐₓ₁,
c) Mixing the at least one analyte of interest, the fluorophore and the quencher for forming a sample,
d) Performing RAMAN spectroscopy, and
e) Determining the at least one analyte of interest via RAMAN spectroscopy.

2. The method of aspect 1, wherein the sample is selected from the group consisting of blood, serum, plasma, synovial fluid, spinal fluid, urine, saliva, and lymphatic fluid, cell cultures, tissue cultures and solid samples such as dried blood spots or tissue extracts.

3. The method of any of the proceeding aspects, wherein the sample is obtained from a patient sample, which is selected from a group consisting of serum, plasma and whole blood sample from an individual.

4. The method of any of the proceeding aspects, wherein the sample is a human sample, preferably a hemolysed whole-blood sample, particularly a hemolysed human whole-blood sample.

5. The method of any of the proceeding aspects, wherein the sample is a water based sample.

6. The method of any of the proceeding aspects, wherein the quencher comprises a hydrophilic group, which is selected from the following: SO₄²⁻; PO₄³⁻, oligonucleotide, quaternary amine, PEG-group, alcohol, COOH.

7. The method of any of the proceeding aspects, wherein the hydrophilic group is an oligonucleotide.

8. The method of any of the proceeding aspects, wherein the quencher comprises a polyaromatic-azo backbone.

9. The method of any of the proceeding aspects, wherein the molecules of the quencher and the molecules of the fluorophore have a distance of smaller than 6 nm or 5 nm or 3 nm.

10. The method of any of the proceeding aspects, wherein the maximum excitation wavelength of the quencher is λₘₐₓ₁+−20 nm.

11. The method of any of the proceeding aspects, wherein the quenching range (absorption range) of the quencher is in the range of 470 nm to 660 nm, preferably 480 nm to 580 nm (borders included) or 550 nm to 650 nm (borders included).

12. The method of any of the proceeding aspects, wherein the quenching is a Förster resonance energy transfer.

13. The method of any of the proceeding aspects, wherein the quencher is a BHQ1 Quencher or a BHQ2 Quencher, preferably wherein the BHQ1 Quencher is modified with a oligonucleotide or wherein the BHQ2 Quencher is modified with a oligonucleotide.

14. The method of any of the proceeding aspects, wherein the analyte of interest is selected from the group consisting of nucleic acid, amino acid, peptide, protein, metabolite, hormones, fatty acid, lipid, carbohydrate, steroid, ketosteroid, secosteroid, a molecule characteristic of a certain modification of another molecule, a substance that has been internalized by the organism, a metabolite of such a substance and combination thereof.

15. The method of any of the proceeding aspects, wherein step (d) is performed in a liquid phase.

16. The method of any of the proceeding aspects, wherein the scattered electromagnetic radiation is an inelastic scattered electromagnetic radiation.

17. The method of any of the proceeding aspects, wherein the scattered electromagnetic radiation is a Stokes scattering and/or an Anti-Stokes scattering.

18. The method of any of the proceeding aspects, wherein the maximum excitation wavelength λₘₐₓ₁ of the monochromatic electromagnetic radiation is smaller than 1064 nm.

19. The method of any of the proceeding aspects, wherein the monochromatic electromagnetic radiation is generated by a krypton ion laser (530.9 and 647.1 nm), He:Ne laser (632.8 nm), Nd:YAG laser (1064 nm and 532 nm), argon ion laser (488.0 and 514.5 nm), or diode laser (630 and 780 nm).

20. The method of any of the proceeding aspects, wherein the fluorophore is selected from the group consisting of chemicals comprising several combined aromatic groups, or planar molecules or cyclic molecules with several x bonds.

21. The method of any of the proceeding aspects, wherein the concentration of fluorophore varies between 2.5 mg/l up to 250 mg/l with a quencher concentration of 0, 51.7 or 62.5 mg/l.

22. The method of any of the proceeding aspects, wherein the sample is a solvent based sample and the quencher is hydrophobic.

23. Use of the method of any one of aspects 1 to 22 for determining the at least one analyte of interest in a sample.

24. The use of aspect 23, wherein the presence or the level of the at least one analyte of interest in a sample is determined.

25. A diagnostic system for determining the at least one analyte of interest in a sample, comprising a spectrometer having
a radiation source,
a sample holder,
a wavelength selector and
a detector, to carry out the method according to any one of aspects 1 to 22.

26. A kit suitable to perform a method according to any of the proceeding aspects 1 to 22 comprising or consisting of
(A) at least one analyte of interest, preferably a deuterated analyte of interest as an internal standard, and
(B) a quencher.

27. Use of a kit of aspect 26 in a method according to any of the proceeding aspects 1 to 22.

### Examples

The following examples are provided to illustrate, but not to limit the presently claimed invention.

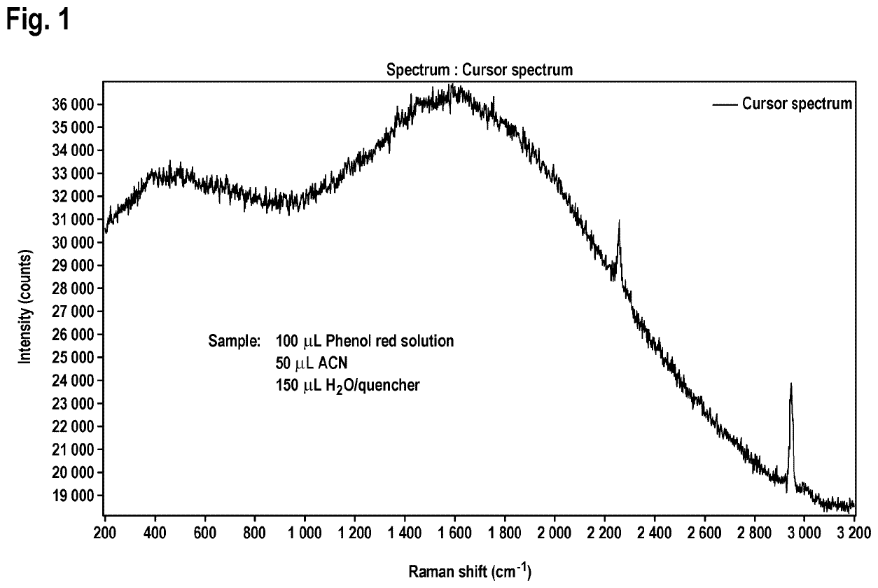

FIG. 1 shows the RAMAN spectra of a acetonitrile as an analyte of interest. The intensitiy (counts) as a function of RAMAN shift in cm⁻¹ is shown. The strong signals of the acetonitrile are visible however the background shows a broad singal that exceeds the intensity of the acetontrile signals. The sample comprises or consists of 100 μl phenol red solutuion as the fluorophore, 50 μl acetonitrile as an analyte of interest and 150 μl water and quencher. The sample can be prepeared by using a concentrated solution of phenol red, mix it with the acetonitrile as the analyte of interest and combine it with the quencher solution. The quencher solution can be prepared by adding water to the quencher solid to reach an concentration of 62.5 mg/l. In order to get a dilution series, the fluorophore is diluted to reach concentrations like 250 mg/l, 125 mg/l, 50 mg/l, 25 mg/l, 12,5 mg/l, 5 mg/l and 2.5 mg/l of fluorophore in the final sample.

The qualitative and/or quantitative determination of acetonitrile as an analyte of interest can be performed as follows:
a) Providing
the acetonitrile, which is capable of emitting scattered electromagnetic radiation when exciting with monochromatic electromagnetic radiation having a maximum excitation wavelength λₘₐₓ₁, e.g. 532 nm, and
phenol red solution fluorophore, which is capable of emitting fluorescent electromagnetic radiation when exciting with the monochromatic electromagnetic radiation having the maximum excitation wavelength λₘₐₓ₁,
b) Providing a quencher, e.g. hydrophilic BHQ1 or BHQ2, which is capable of quenching the fluorophore's fluorescent electromagnetic radiation when exciting with the monochromatic electromagnetic radiation having the maximum excitation wavelength λₘₐₓ₁,
c) Mixing the acetonitrile, phenol red solution and the quencher for forming a sample,
d) Performing RAMAN spectroscopy, and
e) Determining the acetonitrile via RAMAN spectroscopy.

The fluorophore causes fluorescence at 532 nm laser excitation. The RAMAN spectroscopy can be performed with an RAMAN spectrometer, e.g. HORIBA LabRAM HR Evolution. The spectrum in FIG. 1 gives information about how a fluorescence affected spectrum can look like.

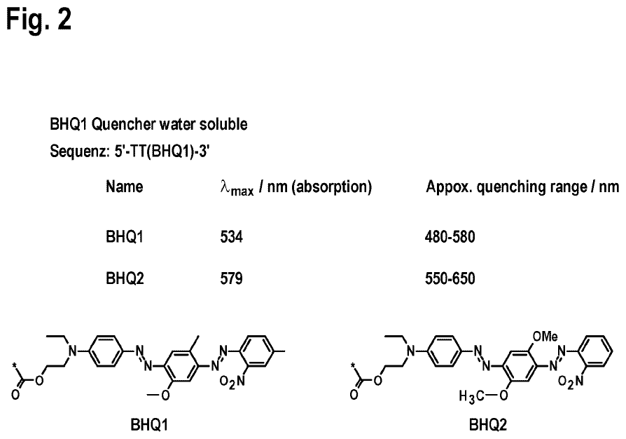

FIG. 2 shows quenchers having an oligonucleotide as a hydrophilic group. The quencher can comprise other or additional hydrophilic groups, which is selected from the following: SO₄²⁻; PO₄³⁻, oligonucleotide, quaternary amine, PEG-group, alcohol, COOH. The quencher have the maximum excitation wavelength λₘₐₓ₁ of 534 nm (hydrophilic BHQ-1) and 573 nm (hydrophilic BHQ-2), respectively. The quencher have a quenching range from 400 to 500 nm (hydrophilic 5′-TTx-3′ X=BHQ1) and 550 m to 650 nm (hydrophilic 5′-TTx-3′ X=BHQ2), respectively.

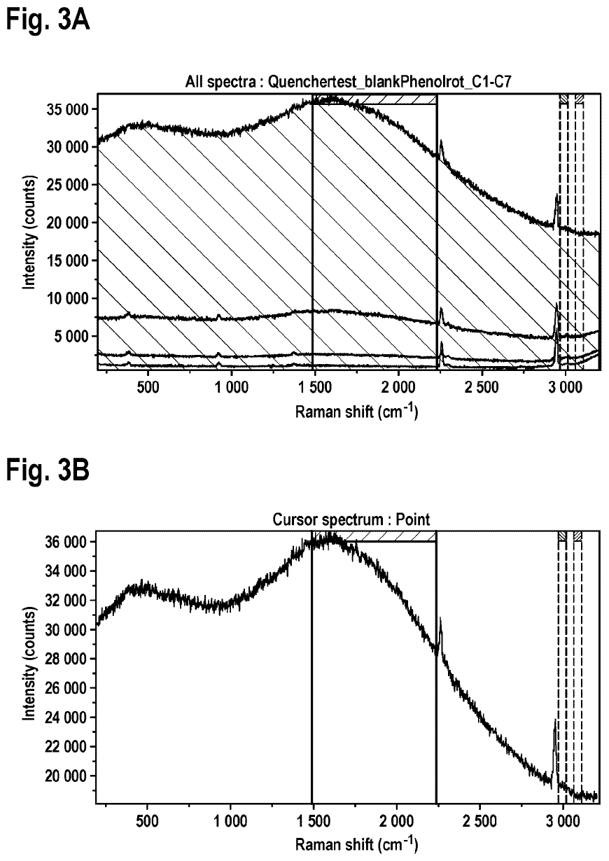

FIGS. 3A to 3C show RAMAN spectra for acetonitrile as an analyte of interest. The measurements were perfomed via a high throughput screening Horiba LabRAM HR Evolution. The picture 3A to 3C show the high throughput screening in the LaSpec6 Software with 3A the overlay of all spectra with different fluorophore concentrations, 3B a single spectra view and 3C the 96 well plate view to perform well selection to show the specific spectrum for each well.

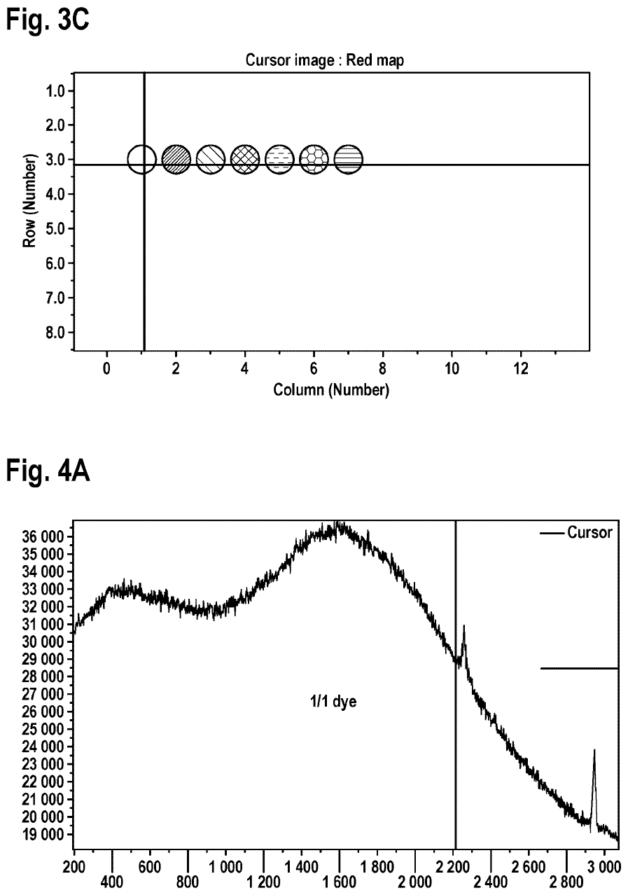

FIGS. 4A and 4B show the RAMAN spectra of a acetonitrile as an analyte of interest in different fluorophore dilution. The sample can be prepared as mentioned for FIG. 1. FIG. 4A shows a “1/1 dye, concentration 250 mg/l fluorophore” and FIG. 4B shows a “1/100 dye, concentration 2.5 mg/l fluorophore”. The Figures show the effect of dilution on the signal to noise ration. As for 4A the spectra shows fluorescence the spectra in 4B shows almost no fluorescence due to the high dilution factor. The dilution has been done by adding water to the fluorophore solution to reach the desired concentration.

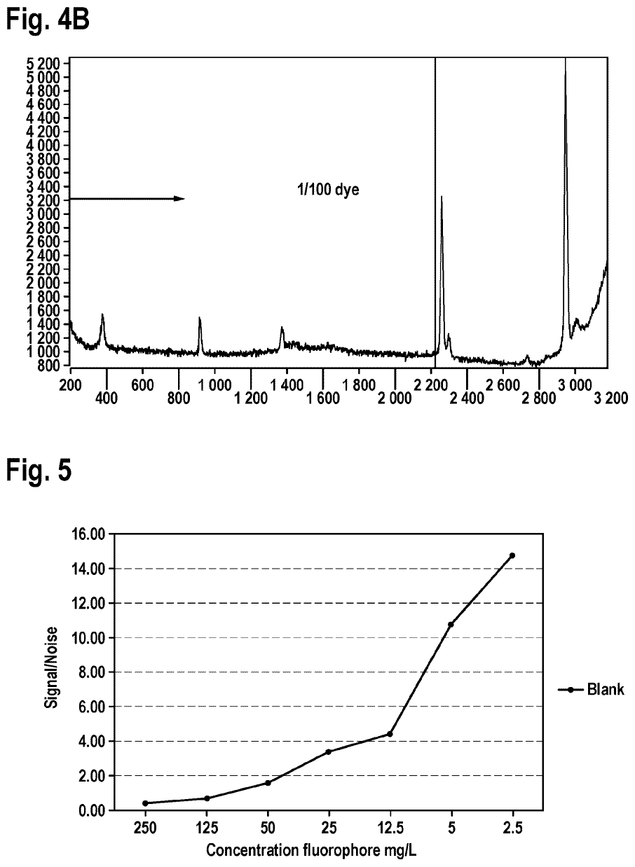

FIG. 5 shows the signal to noise ratio as a function of the fluorophore dilution without any quencher present. With dilution of the fluorophore the acetontril can be detected. This signal to noise ration, calculated between maximum intensitiy of the analyte signal and the maximum signal of the quencher fluorescence (described as noise). The increasing signal to noise ration due to dilution of the fluorophore gives the benchmark for identification of the influence of the quencher on the fluorescence.

FIG. 6 shows the the signal to noise ratio as a function of the fluorophore dilution at different quencher concentrations (0 mg/l (Blank), 41.7 mg/l, 62.5 mg/l). The quencher results in an increased singal to noise ration at higher fluorophore concentration compared to blank sample.

This patent application claims the priority of the European patent application 22209071.4, wherein the content of this European patent application is hereby incorporated by references.

1. A method for determining at least one analyte of interest comprising the following steps:
a) Providing
the at least one analyte of interest, which is capable of emitting scattered electromagnetic radiation when exciting with monochromatic electromagnetic radiation having a maximum excitation wavelength λₘₐₓ₁, and
a fluorophore, which is capable of emitting fluorescent electromagnetic radiation when exciting with the monochromatic electromagnetic radiation having the maximum excitation wavelength λₘₐₓ₁,
b) Providing a quencher, which is capable of quenching the fluorophore's fluorescent electromagnetic radiation when exciting with the monochromatic electromagnetic radiation having the maximum excitation wavelength λₘₐₓ₁,
c) Mixing the at least one analyte of interest, the fluorophore and the quencher for forming a sample,
d) Performing RAMAN spectroscopy, and
e) Determining the at least one analyte of interest via RAMAN spectroscopy.

2. The method of claim 1, wherein the sample is selected from the group consisting of blood, serum, plasma, synovial fluid, spinal fluid, urine, saliva, and lymphatic fluid, cell cultures, tissue cultures and solid samples such as dried blood spots or tissue extracts, preferably wherein the sample is obtained from a patient sample, which is selected from a group consisting of serum, plasma and whole blood sample from an individual and/or wherein the analyte of interest is selected from the group consisting of nucleic acid, amino acid, peptide, protein, metabolite, hormones, fatty acid, lipid, carbohydrate, steroid, ketosteroid, secosteroid, a molecule characteristic of a certain modification of another molecule, a substance that has been internalized by the organism, a metabolite of such a substance and combination thereof.

3. The method of any of the proceeding claims, wherein the sample is a water based sample.

4. The method of any of the proceeding claims, wherein the quencher comprises a hydrophilic group, which is selected from the following: SO₄²⁻; PO₄³⁻, oligonucleotide, quaternary amine, PEG-group, alcohol, COOH.

5. The method of any of the proceeding claims, wherein the hydrophilic group is an oligonucleotide and the quencher comprises a polyaromatic-azo backbone.

6. The method of any of the proceeding claims, wherein the maximum excitation wavelength of the quencher is λₘₐₓ₁+/−20 nm.

7. The method of any of the proceeding claims, wherein the quenching range (absorption range) of the quencher is in the range of 470 nm to 660 nm, preferably 480 nm to 580 nm (borders included) or 550 nm to 650 nm (borders included).

8. The method of any of the proceeding claims, wherein the quencher is a BHQ1 Quencher or a BHQ2 Quencher.

9. The method of any of the proceeding claims, wherein step (d) is performed in a liquid phase.

10. The method of any of the proceeding claims, wherein the concentration of fluorophore varies between 2.5 mg/l up to 250 mg/l compared to a quencher concentration of 0, 51.7 or 62.5 mg/l.

11. The method of any of the proceeding claims, wherein the sample is a solvent based sample and the quencher is hydrophobic.

12. Use of the method of any one of claims 1 to 12 for determining the at least one analyte of interest in a sample.

13. A diagnostic system for determining the at least one analyte of interest in a sample, comprising a spectrometer having
a radiation source,
a sample holder,
a wavelength selector and
a detector, to carry out the method according to any one of claims 1 to 12.

14. A kit suitable to perform a method according to any of the proceeding claims 1 to 12 comprising or consisting of
(A) at least one analyte of interest, preferably a deuterated analyte of interest as an internal standard, and
(B) a quencher.

15. Use of a kit of claim 14 in a method according to any of the proceeding claims 1 to 12.
